(19) United States
(12) Patent Application Publication
(10) Pub. No.: US 2026/0236223 A1
(43) Pub. Date: Aug. 13, 2026

(54) SOUND STACKING

(71) Applicant: Sonos, Inc., Goleta, CA (US)

(72) Inventors: Valentin Fage, Paris (FR); Do Kyun Kim, Paris (FR); Bjay Watanabe Kamwa, Paris (FR); Ahmed Wadie Moutawakil, Paris (FR)

(21) Appl. No.: 19/159,224

(22) PCT Filed: Feb. 20, 2024
(86) PCT No.: PCT/US2024/016465

§ 371 Date: Aug. 22, 2025

Related U.S. Application Data
(60) Provisional application No. 63/486,414, filed on Feb. 22, 2023.

(51) Int. Cl. G06F 3/16

(52) U.S. Cl. CPC G06F 3/167; G06F 3/165

(57) ABSTRACT

Examples described herein relate to audio feedback composed of multiple sounds representing respective states or characteristics that are combined (i.e., “stacked”) to form a composite sound that conveys the states or characteristics concurrently. Such “stacked” sounds may be used in combination with, or as an alternative to, spoken responses to voice inputs. For instance, a networked-microphone device (NMD) may respond to a voice input (e.g., a query for the weather) with a stacked sound representing the weather forecast.

### CROSS-REFERENCE TO RELATED APPLICATION

This application claims the benefit of priority to U.S. Patent Application No. 63/486,414, filed Feb. 22, 2023, which is incorporated herein by reference in its entirety.

### FIELD OF THE DISCLOSURE

The present technology relates to consumer goods and, more particularly, to methods, systems, products, features, services, and other elements directed to voice-assisted control of media playback systems or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings where:

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media play back system configured in accordance with aspects of the disclosed technology.

FIG. 1B is a schematic diagram of the media play back system of FIG. 1A and one or more networks.

FIG. 2A is a functional block diagram of an example playback device.

FIG. 2B is an isometric diagram of an example housing of the playback device of FIG. 2A.

FIG. 2C is a diagram of an example voice input.

FIG. 2D is a graph depicting an example sound specimen in accordance with aspects of the disclosure.

FIGS. 3A, 3B, 3C, 3D and 3E are diagrams showing example playback device configurations in accordance with aspects of the disclosure.

FIG. 4 is a functional block diagram of an example controller device in accordance with aspects of the disclosure.

FIGS. 5A and 5B are controller interfaces in accordance with aspects of the disclosure.

FIG. 6 is a message flow diagram of a media playback system.

FIGS. 7A and 7B are diagrams illustrating example voice inputs and responses in accordance with aspects of the disclosed technology.

FIG. 8 is a schematic diagram of a portion of the media playback system of FIG. 1A and one or more networks.

FIGS. 9A, 9B, and 9C are diagrams illustrating example sound stacking in accordance with aspects of the disclosed technology.

FIG. 10 is a flow diagram of an example method in accordance with aspects of the disclosed technology.

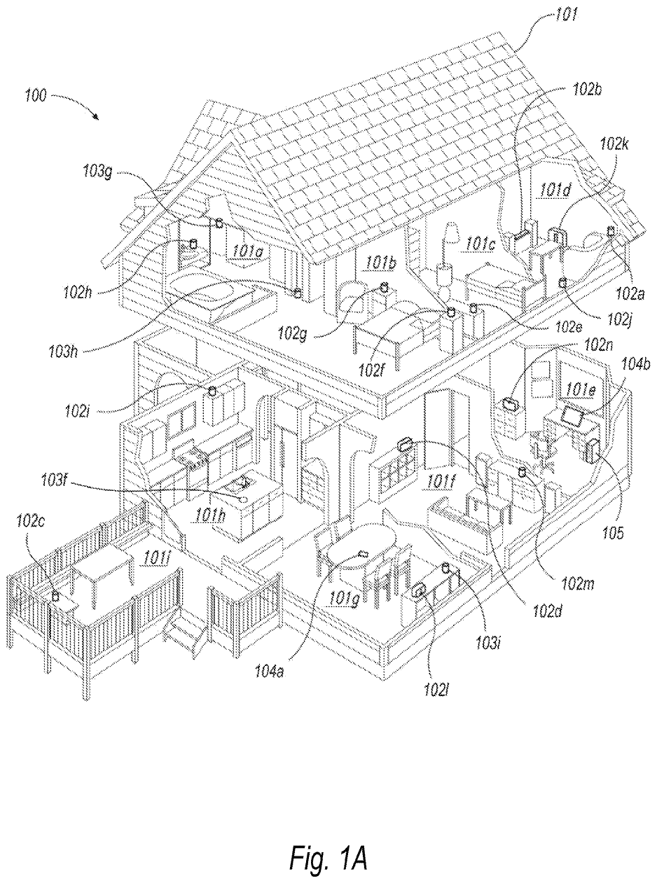

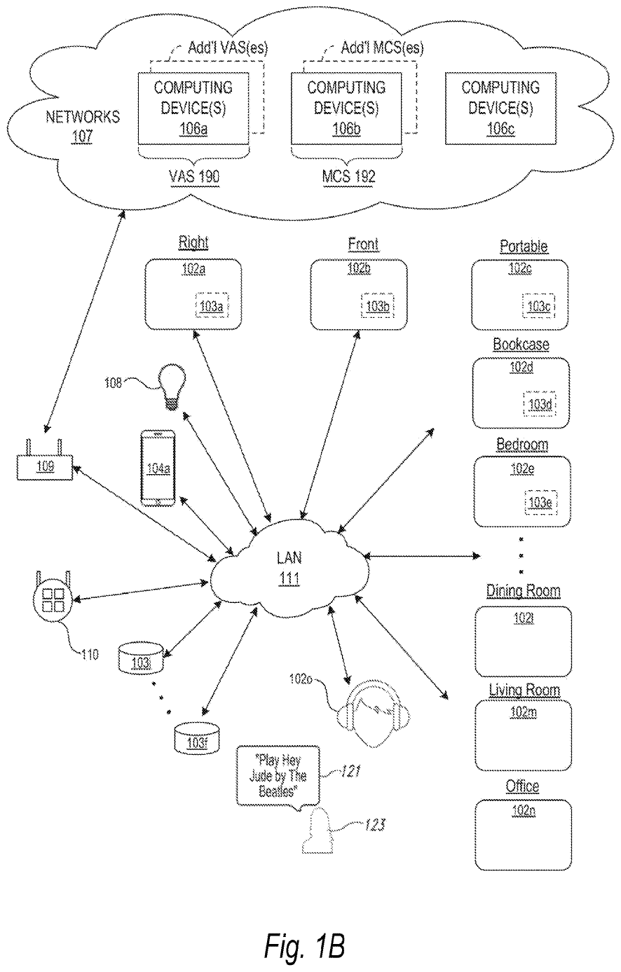

The drawings are for purposes of illustrating example embodiments, but it should be understood that the inventions are not limited to the arrangements and instrumentality shown in the drawings. In the drawings, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### DETAILED DESCRIPTION

### I. Overview

Examples described herein relate to audio composed of multiple sounds representing respective states or characteristics that are combined (i.e., “stacked”) to form a composite sound that conveys the states or characteristics concurrently. Such “stacked” sounds may be used in combination with, or as an alternative to, spoken responses to voice inputs. For instance, a networked-microphone device (NMD) may respond to a voice input (e.g., a query for the weather) with a stacked sound representing the weather forecast.

Current voice assistants typically respond to voice inputs, such as queries for information, with spoken responses. For example, when a user speaks “what is the weather” to an NMD, a voice assistant may respond to the query by causing the NMD to play back a spoken response that describes the weather in spoken words. Such a response may be structured in a certain consistent manner with certain variables that have different values based on the current state of the weather. For instance, such a spoken response may be structured as “Currently, in <city>, its <current_temp>, with <weather_state>. Today, you can expect <weather_state>, with a high of <max_temp_today>and a low of <min_temp_today>” with the bracketed text representing variables that change value based on location, weather conditions, and the weather forecast.

An example sound-stacked response may include two or more non-spoken sounds, such as ambient sounds, possibly in combination with a spoken response. Each ambient sound may correspond to a specific characteristic that is to be conveyed to the user. For example, when a user speaks “what is the weather in Paris” to an NMD, a voice assistant may respond to the query by playing a first ambient sound representing heavy rain (e.g., a sound of heavy rain falling on a roof) and a second ambient sound representing thunderstorms (e.g., a sound of thunder), perhaps along with a spoken response (e.g., “Currently in Paris, it's 3 degrees with heavy rain and thunderstorms”). Using multiple types of audio feedback, such as in the foregoing example, may increase the effectiveness of the audio feedback and/or improve the user's enjoyment of receiving the audio feedback, among other possible benefits.

By stacking sounds, the NMD can represent many combinations of characteristics without storing individual recordings of each combination. For example, with respect to weather, an NMD may store a limited number of ambient sounds representing respective weather conditions and then stack them in different combinations to represent different weather conditions. Such stacking techniques may be particularly useful in applications where data storage and/or bandwidth is limited, such as in low-cost or portable devices.

Yet further, in some examples, a device, such as an NMD, may further stretch its library of sounds by mixing two or more sounds that describe different degrees of a state to describe a state that is not in the library. For instance, an example NMD may store a first ambient sound representing heavy rain (e.g., as described above, a sound of heavy rain falling on a roof) and a second ambient sound representing light rain (e.g., a sound of light rain pattering). These sounds may be generated in such a way that mixing the sounds forms a third ambient sound representing medium rain. This third ambient sound may then be stacked with an additional ambient sound representing another weather characteristic (e.g., wind) and played back, perhaps concurrently with a spoken response.

As noted above, example techniques relate to sound stacking. An example involves a playback device comprising at least one audio transducer, at least one microphone, a network interface, at least one processor, and data storage comprising instructions that are executable by the at least one processor such that the playback device is configured to: receive, via the at least one microphone, sound data comprising a voice input; determine that the voice input includes a request for a weather forecast; retrieve, via the network interface, weather data representing a weather forecast, the weather data comprising a first weather characteristic and a second weather characteristic; determine, from a plurality of ambient sounds stored in the data storage, multiple ambient sounds representing the weather data, the multiple ambient sounds comprising (i) a first ambient sound representing the first weather characteristic and (ii) a second ambient sound representing the second weather characteristic; and responsive to the determination that the voice input includes the request for the weather forecast, play back, via the at least one audio transducer, (i) a voice response representing the weather data in spoken words and (ii) concurrently with the voice response representing the weather data in the spoken words, the multiple ambient sounds such that playback of the first ambient sound and playback of the second ambient sound form a combined ambient sound representing the weather data.

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one element or function is a necessary result of another function or element. For the sake of brevity, functions are generally described as being based on another function when a functional link exists; however, such disclosure should be understood as disclosing either type of functional relationship.

### II. Example Operation Environment

FIGS. 1A and 1B illustrate an example configuration of a media play back system 100 (or “MPS 100”) in which one or more embodiments disclosed herein may be implemented.
Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b, (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-103i), and controller devices 104a and 104b (collectively “controller devices 104”). Referring to FIG. 1B, the home environment may include additional and/or other computing devices, including local network devices, such as one more smart illumination devices 108 (FIG. 1B), a smart thermostat 110, and a local computing device 105 (FIG. 1A).

In embodiments described below, one or more of the various playback devices 102 may be configured as portable playback devices, while others may be configured as stationary playback devices. For example, the headphones 1020 (FIG. 1B) are a portable playback device, while the play back device 102d on the bookcase may be a stationary device. As another example, the playback device 102c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices 102, 103, and 104 and/or other network devices of the MPS 100 may be coupled to one another via point-to-point connections and/or over other connections, which may be wired and/or wireless, via a network 111, such as a LAN including a network router 109. For example, the playback device 102j in the Den 101d (FIG. 1A), which may be designated as the “Left” device, may have a point-to-point connection with the play back device 102a, which is also in the Den 101d and may be designated as the “Right” device. In a related embodiment, the Left playback device 102j may communicate with other network devices, such as the playback device 102b, which may be designated as the “Front” device, via a point-to-point connection and/or other connections via the NETWORK 111.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a VAS and at least one remote computing device associated with a media content service (“MCS”). For instance, in the illustrated example of FIG. 1B, remote computing devices 106 are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the playback devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a play back device, such as a speaker or related electronics. For instance, in such cases, a stand-alone NMD may not produce audio output or may produce limited audio output (e.g., relatively low-quality audio output).

The various playback and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to play back device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 102l, 102m, and 102n, which are named “Bedroom,” “Dining Room,” “Living Room,” and “Office,” respectively. Further, certain playback devices may have functionally descriptive names. For example, the playback devices 102a and 102b are assigned names “Right” and “Front,” respectively, because these two devices are configured to provide specific audio channels during media play back in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the network 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. application Ser. No. 15/438,749 filed Feb. 21, 2017, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. application Ser. No. 15/438,749.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 1021, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Application No.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single play back device 102 and/or a single NMD 103. In some examples of such cases, the NETWORK 111 (FIG. 1B) may be eliminated and the single playback device 102 and/or the single NMD 103 may communicate directly with the remote computing devices 106-d. In some embodiments, a telecommunication network (e.g., an LTE network, a 5G network, etc.) may communicate with the various playback, network microphone, and/or controller devices 102-104 independent of a LAN.

a. Example Playback & Network Microphone Devices

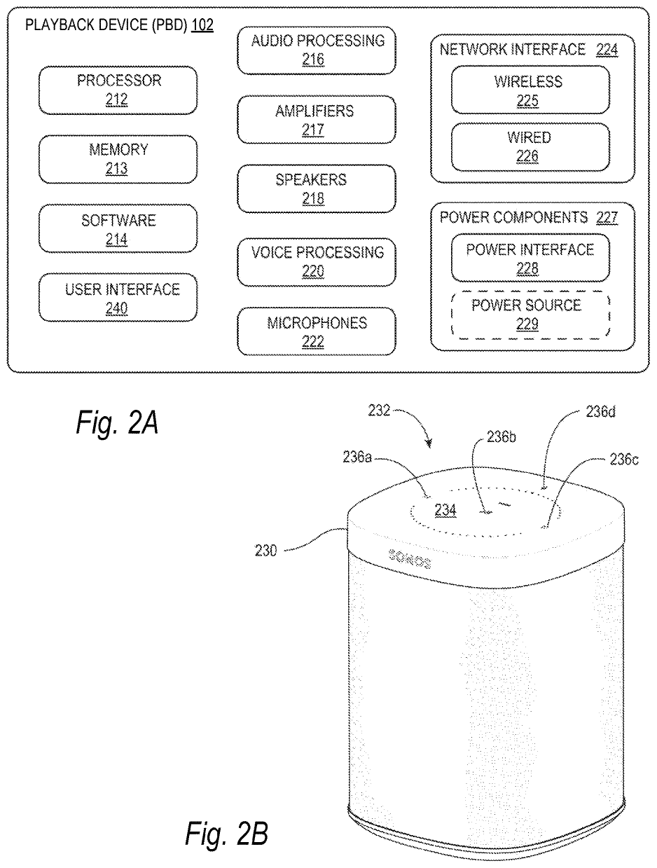

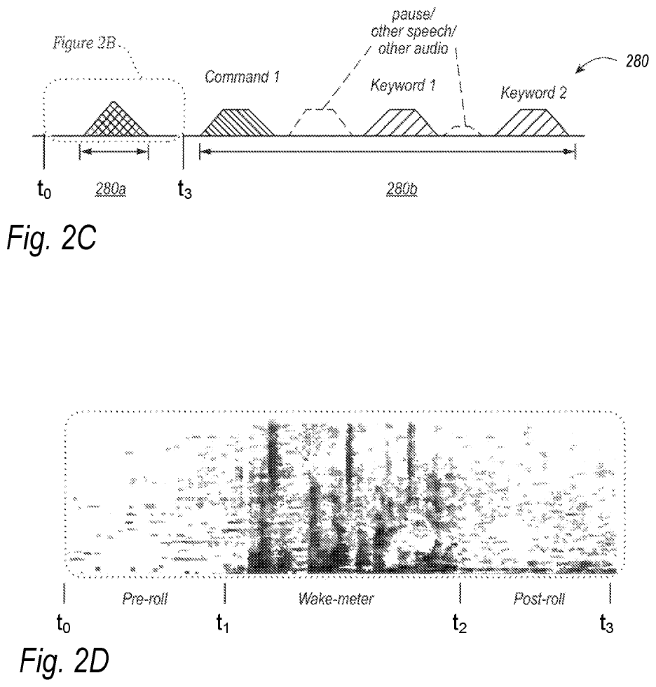

FIG. 2A is a functional block diagram illustrating certain aspects of one of the play back devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the play back device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for play back.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the playback device to external speakers. In certain embodiments, a playback device may include neither the speakers 218 nor the audio amplifiers 217, but instead may include an audio interface (not shown) for connecting the play back device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A include both wired and wireless interfaces, the playback device 102 may in some implementations include only wireless interface(s) or only wired interface(s).

In general, the network interface 224 facilitates data flow between the playback device 102 and one or more other devices on a data network. For instance, the play back device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the play back device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the play back device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the playback device 102.

By way of illustration, SONOS, Inc. presently offers (or has offered) for sale certain playback devices that may implement certain of the embodiments disclosed herein, including a “PLAY:1,” “PLAY:3,” “PLAY:5,” “PLAYBAR,” “CONNECT: AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIGS. 2A or 2B or to the SONOS product offerings. For example, a playback device may include, or otherwise take the form of, a wired or wireless headphone set, which may operate as a part of the MPS 100 via a network interface or the like. In another example, a playback device may include or interact with a docking station for personal mobile media playback devices. In yet another example, a playback device may be integral to another device or component such as a television, a lighting fixture, or some other device for indoor or outdoor use.

FIG. 2C is a diagram of an example voice input 280 that may be processed by an NMD or an NMD-equipped playback device. The voice input 280 may include a keyword portion 280a and an utterance portion 280b. The keyword portion 280a may include a wake word or a local keyword.

In the case of a wake word, the keyword portion 280a corresponds to detected sound that caused a VAS wake-word event. In practice, a wake word is typically a predetermined nonce word or phrase used to “wake up” an NMD and cause it to invoke a particular voice assistant service (“VAS”) to interpret the intent of voice input in detected sound. For example, a user might speak the wake word “Alexa” to invoke the AMAZON® VAS, “Ok, Google” to invoke the GOOGLE® VAS, or “Hey, Siri” to invoke the APPLE® VAS, among other examples. In practice, a wake word may also be referred to as, for example, an activation-, trigger-, wakeup-word or phrase, and may take the form of any suitable word, combination of words (e.g., a particular phrase), and/or some other audio cue.

The utterance portion 280b corresponds to detected sound that potentially comprises a user request following the keyword portion 280a. An utterance portion 280b can be processed to identify the presence of any words in detected-sound data by the NMD in response to the event caused by the keyword portion 280a. In various implementations, an underlying intent can be determined based on the words in the utterance portion 280b. In certain implementations, an underlying intent can also be based or at least partially based on certain words in the keyword portion 280a, such as when keyword portion includes a command keyword. In any case, the words may correspond to one or more commands, as well as a certain command and certain keywords.

A keyword in the voice utterance portion 280b may be, for example, a word identifying a particular device or group in the MPS 100. For instance, in the illustrated example, the keywords in the voice utterance portion 280b may be one or more words identifying one or more zones in which the music is to be played, such as the Living Room and the Dining Room (FIG. 1A). In some cases, the utterance portion 280b may include additional information, such as detected pauses (e.g., periods of non-speech) between words spoken by a user, as shown in FIG. 2C. The pauses may demarcate the locations of separate commands, keywords, or other information spoke by the user within the utterance portion 280b.

Based on certain command criteria, the NMD and/or a remote VAS may take actions as a result of identifying one or more commands in the voice input. Command criteria may be based on the inclusion of certain keywords within the voice input, among other possibilities. Additionally, state and/or zone-state variables in conjunction with identification of one or more particular commands. Control-state variables may include, for example, indicators identifying a level of volume, a queue associated with one or more devices, and play back state, such as whether devices are playing a queue, paused, etc. Zone-state variables may include, for example, indicators identifying which, if any, zone players are grouped.

In some implementations, the MPS 100 is configured to temporarily reduce the volume of audio content that it is playing upon detecting a certain keyword, such as a wake word, in the keyword portion 280a. The MPS 100 may restore the volume after processing the voice input 280. Such a process can be referred to as ducking, examples of which are disclosed in U.S. patent application Ser. No. 15/438,749, incorporated by reference herein in its entirety.

FIG. 2D shows an example sound specimen. In this example, the sound specimen corresponds to the sound-data stream (e.g., one or more audio frames) associated with a spotted wake word or command keyword in the keyword portion 280a of FIG. 2A. As illustrated, the example sound specimen comprises sound detected in an NMD's environment (i) immediately before a wake or command word was spoken, which may be referred to as a pre-roll portion (between times t₀ and t₁), (ii) while a wake or command word was spoken, which may be referred to as a wake-meter portion (between times t₁ and t₂), and/or (iii) after the wake or command word was spoken, which may be referred to as a post-roll portion (between times t₂ and t₃). Other sound specimens are also possible. In various implementations, aspects of the sound specimen can be evaluated according to an acoustic model which aims to map mels/spectral features to phonemes in a given language model for further processing. For example, automatic speech recognition (ASR) may include such mapping for command-keyword detection. Wake-word detection engines, by contrast, may be precisely tuned to identify a specific wake-word, and a downstream action of invoking a VAS (e.g., by targeting only nonce words in the voice input processed by the playback device).

ASR for local keyword detection may be tuned to accommodate a wide range of keywords (e.g., 5, 10, 100, 1,000, 10,000 keywords). Local keyword detection, in contrast to wake-word detection, may involve feeding ASR output to an onboard, local NLU which together with the ASR determine when local keyword events have occurred. In some implementations described below, the local NLU may determine an intent based on one or more keywords in the ASR output produced by a particular voice input. In these or other implementations, a playback device may act on a detected command keyword event only when the playback devices determines that certain conditions have been met, such as environmental conditions (e.g., low background noise).

b. Example Playback Device Configurations

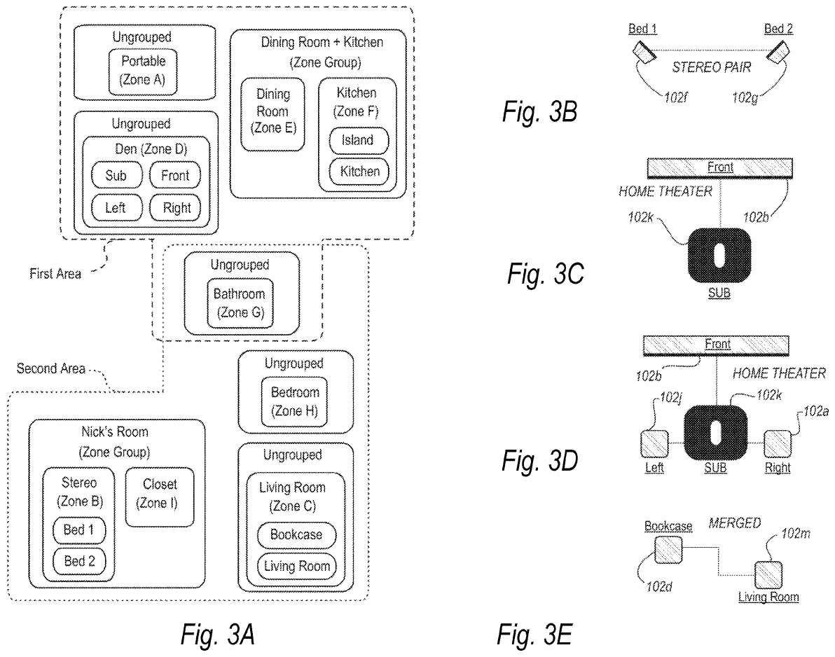

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the play back device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged play back devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.” In various embodiments, a zone may take on the name of one of the play back devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the playback devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in previously referenced U.S. patent application Ser. No. 15/438,749. In some embodiments, a stand-alone NMD may not be assigned to a zone.

Zones of individual, bonded, and/or merged devices may be arranged to form a set of playback devices that playback audio in synchrony. Such a set of play back devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the play back devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room+Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the MPS 100, which may be shared from time to time among the devices so that one or more of the devices have the most recent data associated with the system.

In some embodiments, the memory 213 of the play back device 102 may store instances of various variable types associated with the states. Variables instances may be stored with identifiers (e.g., tags) corresponding to type. For example, certain identifiers may be a first type “a1” to identify playback device(s) of a zone, a second type “b1”to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room +Kitchen group and that devices 103f and 102i are bonded. Identifiers associated with the Kitchen may indicate the same or similar information by virtue of the Kitchen being part of the Dining Room +Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In embodiments described below, the memory 213 is configured to store a set of command data for selecting a particular VAS when processing voice inputs. During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone.

For instance, the user may be in the Office zone where the playback device 102n is playing the same hip-hop music that is being playing by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. As another example, if one or more play back devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

c. Example Controller Devices

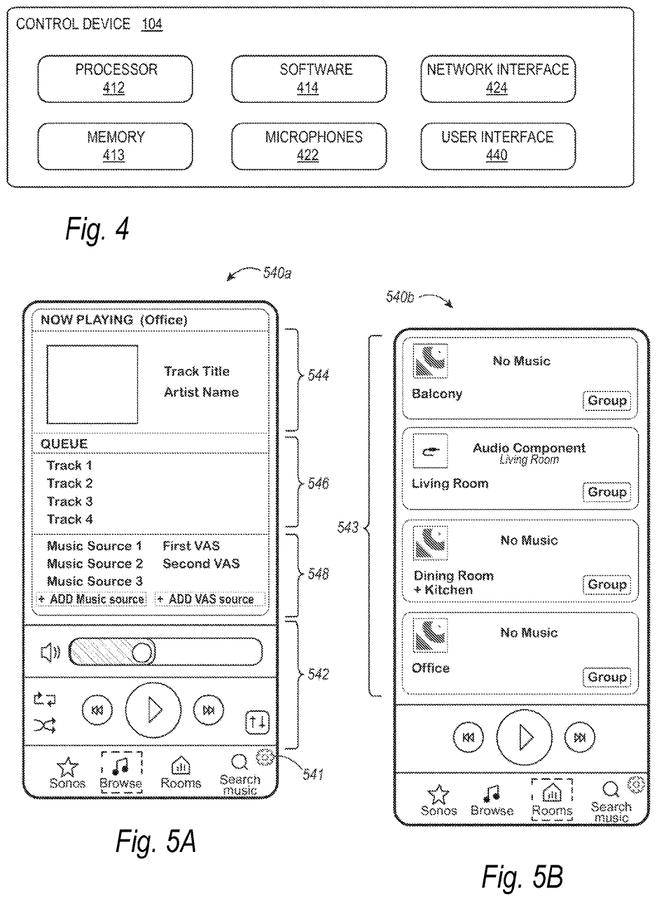

FIG. 4 is a functional block diagram illustrating certain aspects of a selected one of the controller devices 104 of the MPS 100 of FIG. 1A. Such controller devices may also be referred to herein as a “control device” or “controller.” The controller device shown in FIG. 4 may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

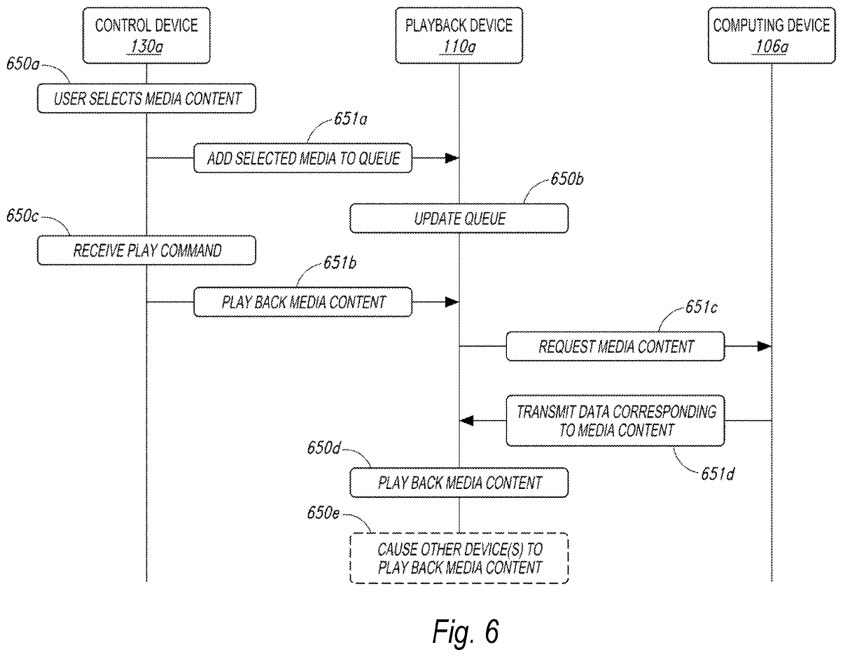

As shown in FIG. 4, the controller device 104 also includes a user interface 440 that is generally configured to facilitate user access and control of the MPS 100. The user interface 440 may include a touch-screen display or other physical interface configured to provide various graphical controller interfaces, such as the controller interfaces 540a and 540b shown in FIGS. 5A and 5B. Referring to FIGS. 5A and 5B together, the controller interfaces 540a and 540b includes a playback control region 542, a playback zone region 543, a playback status region 544, a playback queue region 546, and a sources region 548. The user interface as shown is just one example of an interface that may be provided on a network device, such as the controller device shown in FIG. 4, and accessed by users to control a media playback system, such as the MPS 100. Other user interfaces of varying formats, styles, and interactive sequences may alternatively be implemented on one or more network devices to provide comparable control access to a media playback system.

The playback control region 542 (FIG. 5A) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The playback control region 542 may also include selectable icons that, when selected, modify equalization settings and/or playback volume, among other possibilities.

The playback zone region 543 (FIG. 5B) may include representations of play back zones within the MPS 100. The playback zones regions 543 may also include a representation of zone groups, such as the Dining Room +Kitchen zone group, as shown.

In some embodiments, the graphical representations of playback zones may be selectable to bring up additional selectable icons to manage or configure the playback zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 543 (FIG. 5B) may be dynamically updated as playback zone or zone group configurations are modified.

The playback status region 544 (FIG. 5A) may include graphical representations of audio content that is presently being played, previously played, or scheduled to play next in the selected playback zone or zone group. The selected playback zone or zone group may be visually distinguished on a controller interface, such as within the playback zone region 543 and/or the playback status region 544. The graphical representations may include track title, artist name, album name, album year, track length, and/or other relevant information that may be useful for the user to know when controlling the MPS 100 via a controller interface.

The playback queue region 546 may include graphical representations of audio content in a playback queue associated with the selected playback zone or zone group. In some embodiments, each playback zone or zone group may be associated with a playback queue comprising information corresponding to zero or more audio items for playback by the playback zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a play back queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first play back queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or may be associated with a new play back queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 5A and 5B, the graphical representations of audio content in the play back queue region 646 (FIG. 5A) may include track titles, artist names, track lengths, and/or other relevant information associated with the audio content in the play back queue. In one example, graphical representations of audio content may be selectable to bring up additional selectable icons to manage and/or manipulate the play back queue and/or audio content represented in the playback queue. For instance, a represented audio content may be removed from the playback queue, moved to a different position within the playback queue, or selected to be played immediately or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 548 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to one or both of the NMDs 102a and 102b in the Living Room shown in FIG. 1A, and a second VAS to the NMD 103f in the Kitchen. Other examples are possible.

d. Example Audio Content Sources

The audio sources in the sources region 548 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a play back device directly from a corresponding audio content source (e.g., via a line-in connection). In another example, audio content may be provided to a playback device over a network via one or more other playback devices or network devices. As described in greater detail below, in some embodiments audio content may be provided by one or more media content services.

Example audio content sources may include a memory of one or more playback devices in a media play back system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media play back system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

FIG. 6 is a message flow diagram illustrating data exchanges between devices of the MPS 100. At step 650a, the MPS 100 receives an indication of selected media content (e.g., one or more songs, albums, playlists, podcasts, videos, stations) via the control device 104. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 104 transmits a message 651a to the playback device 102 (FIGS. 1A-1C) to add the selected media content to a playback queue on the playback device 102.

At step 650b, the playback device 102 receives the message 651a and adds the selected media content to the playback queue for play back.

At step 650c, the control device 104 receives input corresponding to a command to play back the selected media content. In response to receiving the input corresponding to the command to play back the selected media content, the control device 104 transmits a message 651b to the play back device 102 causing the playback device 102 to play back the selected media content. In response to receiving the message 651b, the playback device 102 transmits a message 651c to the computing device 106 requesting the selected media content. The computing device 106, in response to receiving the message 651c, transmits a message 651d comprising data (e.g., audio data, video data, a URL, a URI) corresponding to the requested media content.

At step 650d, the playback device 102 receives the message 651d with the data corresponding to the requested media content and plays back the associated media content.

At step 650e, the playback device 102 optionally causes one or more other devices to play back the selected media content. In one example, the playback device 102 is one of a bonded zone of two or more players (FIG. 1M). The playback device 102 can receive the selected media content and transmit all or a portion of the media content to other devices in the bonded zone. In another example, the playback device 102 is a coordinator of a group and is configured to transmit and receive timing information from one or more other devices in the group. The other one or more devices in the group can receive the selected media content from the computing device 106, and begin playback of the selected media content in response to a message from the playback device 102 such that all of the devices in the group play back the selected media content in synchrony.

Within examples, such messages may conform to one or more protocols or interfaces (e.g., an Application Programming Interface). A platform API may support one or more namespaces that include controllable resources (e.g., the playback devices 102 and features thereof). Various functions may modify the resources and thereby control actions on the play back devices 102. For instance, HTTP request methods such as GET and POST may request and modify various resources in a namespace. Example namespaces in a platform API include playback (including controllable resources for playback), playbackMetadata (including metadata resources related to playback), volume (including resources for volume control), playlist (including resources for queue management), and groupVolume (including resources for volume control of a synchrony group), among other examples. Among other examples, such messages may conform to a standard, such as universal-plug-and-play (uPnP).

### III. Example Sound Stacking

Examples described herein relate to stacking multiple sounds representing respective states or characteristics to form a composite sound that conveys the states or characteristics concurrently. These stacked sounds may be used by a device, such as a playback device or network-microphone device, to provide audio feedback to a user. For instance, a networked-microphone device (NMD) may respond to a voice input (e.g., a query for the weather) with a two or more non-spoken (e.g., ambient) sounds representing the current weather and/or weather forecast, perhaps in combination with a spoken response to the voice input.

Voice assistants typically respond to voice inputs, such as queries for information, with spoken responses. For instance, when a user speaks “what is the weather” to an NMD, a voice assistant may respond to the query by causing the NMD to play back a spoken response that describes the weather in spoken words. The spoken response typically are structured in a certain consistent manner with certain variables that have different values based on the current state of the weather. For instance, such a spoken response may be structured as “It's currently <weather_state1> and <current_temp>. Expect <weather_state2> starting tonight. Temperature will be <contextual_answer> averaging about <avg_temp>” with the bracketed text representing variables that change value based on location, weather conditions, and the weather forecast.

The structure of the spoken response may change based on the query in the voice input. For instance, continuing with the weather example, a more focused query in a voice input, such as “What's the temperature for today?” may result in a shorter response, such as “The high temperature will be <max_temp> and the low will be <min_temp_today>”. As another example, the voice input “Will it rain today?” may generate a brief contextual response, such as “<contextual_answer> today” where the <contextual_answer> could be positive (e.g., “Yes, rain today” or negative (e.g., “No, no rain today”) depending on context (i.e., weather data representing the corresponding weather states).

In contrast to such spoken response, within certain examples, the stacked sounds are non-verbal. Instead of spoken words, the stacked sounds may convey state information using non-verbal cues that are generally indicative of the state(s). Such non-verbal cues may include ambient sounds that are representative of the state(s). For instance, continuing the weather example, the states of “heavy rain” and “thunderstorms” may be conveyed via a first sound of heaving rainfall on a roof and a second sound of thunder, which are stacked together to represent both states concurrently during playback.

As noted above, a user may speak a voice input that includes a query to a network-microphone device, such as the network microphone device 103c (which is integrated into the example playback device 102d) or the network microphone device 103i (which is stand-alone), among other examples. For the sake of description, such network microphone devices are referred to as the network microphone device (NMD) 103. After capturing a voice input, the NMD 103 may send data representing the captured voice input to a voice assistant service, such as the voice assistant service 190 (FIG. 1B).

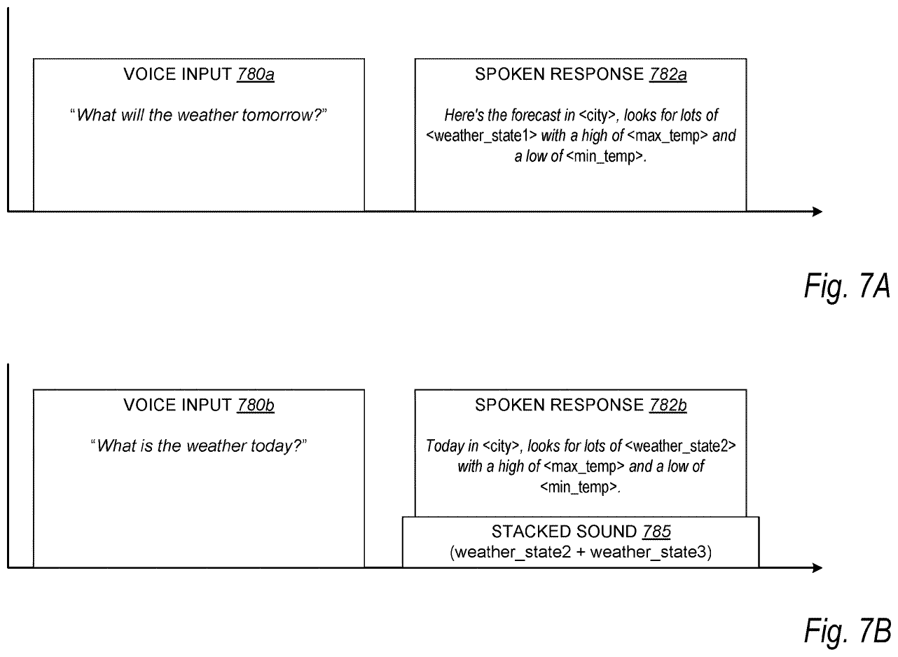

After processing the voice input, the voice assistant service 190 sends back data representing a spoken response to the voice input, which is played back by the NMD 103. FIG. 7A is a diagram illustrating a first example including a voice input 780a captured by the NMD 103, which includes a query for a weather forecast. The voice input 780a is followed by a spoken response 782a played back by the NMD 103, which includes a spoken description of the weather forecast. As shown, the spoken description includes a variable representing the location (<city>), as well as a variable for a first weather state (<weather_state1>) and variables for the high and low temperatures (<max_temp>, <min_temp>).

In example voice input responses that include stacked sounds, the stacked sounds may be played back concurrently with a spoken response. To illustrate, FIG. 7B is a diagram showing a second example including a voice input 780b captured by the NMD 103, which includes a query for a weather forecast. Similar to the first example, the voice input 780b is followed by a spoken response 782a played back by the NMD 103, which includes a spoken description of the weather forecast, as shown. Similar to the spoken response 782a, the spoken response 782b includes a variable representing the location (<city>), as well as a variable for a first weather state (<weather_state1>) and variables for the high and low temperatures (<max_temp>, <min_temp>).

In addition to the spoken response, the NMD 103 plays back a stacked sound 785. In this example, the stacked sound includes two sounds representing respective weather states (i.e., weather_state2 and weather_state3). The NMD 103 may combine these sounds using any suitable technique, such as mixer. For instance, referring to FIG. 2A, the playback device 102 (which may include an integrated NMD 103), may mix two or more non-verbal sounds using a mixer implemented in the audio processing components 216, among other examples.

Within examples, the sounds for stacking are engineered to facilitate combination. For instance, each sound may be adjusted in one or more frequency bins (e.g., via equalization) for compatibility with the other sounds, such as by cutting or boosting certain frequencies where stacking the sounds may create unwanted artifacts. Such engineering may be performed prior to the sounds being stored on the NMD 103, or by the NMD 103, within various examples.

In this example, one of the weather states represented by the stacked sound 785 is the same weather state (i.e., weather_state2) that is also in the spoken response 782b. In this manner, the stacked sound 785 provide an additional manner of conveying a state. For instance, an ambient sound representing rain (e.g., raindrops falling on a roof) may reinforce or otherwise more effectively convey the weather state represented in the spoken response 782b. Furthermore, some users may enjoy listening to the ambient sounds when querying information via a voice assistant.

Yet further, in this example, the second weather state represented by the stacked sound 785 is a different weather state (i.e., weather_state3) which is not represented in the spoken response 782b. For instance, the second weather state may include an ambient sound representing wind (e.g., wind rustling branches), which was excluded from the spoken response 782b (e. g,. so as to keep the spoken response 782b to a practical length). By providing an additional weather state, using stacked sounds may convey more information in the same or similar amount of time (which may be a shorter amount of time than if the same information was conveyed solely via spoken response). Given the differences in the types of sounds (e.g., ambient vs. spoken word), users typically are able to comprehend the additional information (i.e., the additional state(s)) concurrently.

Within examples, the NMD 103 may select two or more non-spoken sounds from among a library of sounds. Following a query for information, the NMD 103 may determine a first sound from a first state indicated by queried data and a second sound from a second state indicated by the queried data. For instance, queried weather data may include a first weather state and a second weather state. The NMD 103 may determine that a first sound corresponds to the first weather state and may also determine that a second sound corresponds to the second weather state.

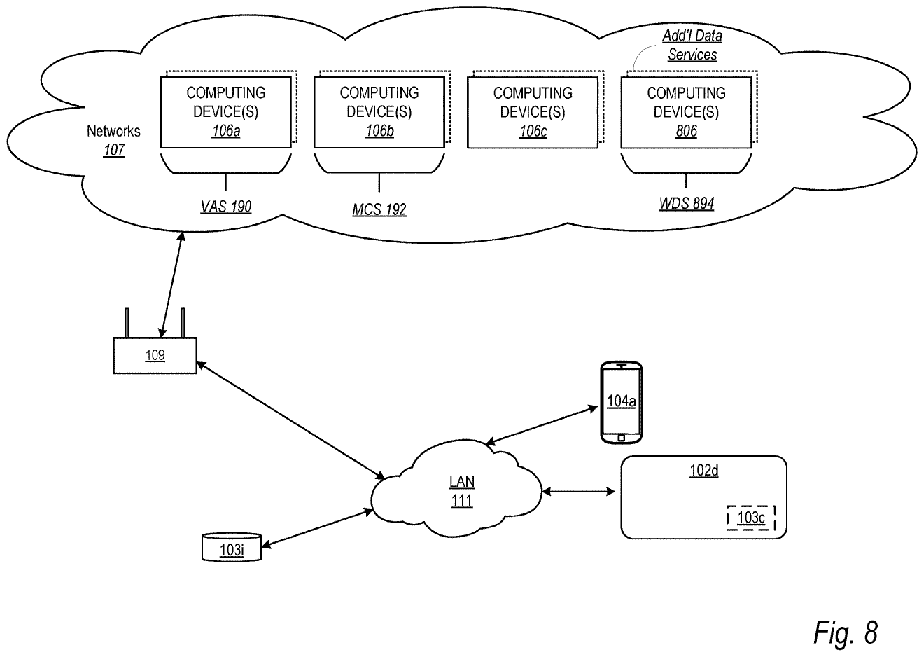

The NMD 103 may query information, such as weather data, to determine the sounds from one or more cloud servers. To illustrate, FIG. 8 is a diagram illustrating an alternative view of the media playback system of FIG. 1A and one or more networks. For the sake of brevity, only a subset of possible devices in the media playback system 100 are shown. FIG. 8 shows the NMD 103i and the playback device 102d (including the NMD 103c) as examples of NMDs that may ultimately play back stacked sounds representing respective states. These NMDs are still referred to collectively as the NMD 103.

To determine the sounds, the NMD 103 may query one or more data services located in the cloud. For example, to obtain weather data, the NMD 103 may query a weather data service (WDS) 894, which may be implemented by software executing on one or more computing devices 806. The WDS 894 may provide an application programming interface (API) to facilitate requests of weather data (e.g., for a fee or subscription-based). In such examples, the NMD 103 may send a query for certain weather data (e.g., for a certain location and date/time) via one or more networks (e.g., the LAN 111 and/or the networks 107) to the WDS 894. After receiving such a query, the WDS 894 may return weather data in a certain format (e.g., a format defined by the API and expected by the NMD 103), which the NMD 103 can parse to make determinations about the weather states represented therein.

As described in Section II, in some implementations, the NMD 103 may process certain voice inputs, such as playback commands, locally. On the other hand, some types of voice inputs might not be able to be processed locally, as they require information not available locally to the NMD 103. In such instances, the NMD 103 may fall back to processing via a cloud-based voice assistant service, such as the voice assistant service 190.

By having access to data services such as the WDS 894, the NMD 103 may process more types of voice inputs locally. Specifically, the NMD 103 may process certain voice inputs that represent queries for information, such as weather forecasts, locally, despite not having such information available locally. Such local processing may enhance privacy since the NMD 103 need not rely upon cloud-based voice assistants, such as the VAS 190 for processing of such voice inputs.

Moreover, in some examples, after obtaining user consent, data queries may be routed through the computing devices 106c, which may further enhance privacy. Specially, such routing may anonymize the queries by aggregating queries from a large number of users though a single source. In this manner, data services, such as the WDS 894, may be unable to attribute queries to an individual user.

In some examples, the library of sounds is stored in data storage on the NMD 103. Storing such a library of sounds locally may reduce network bandwidth usage, which may benefit resource-limited devices such as mobile devices, as well as other types of devices. Storing such a library locally may also enhance privacy since the selected sounds are not revealed to another device (e.g., a server) that is storing the library of sounds.

In some examples, the NMD 103 may, as appropriate, download additional sounds to its library, such as when new sounds become available or when a state is not able to be represented by sounds stored in the local library. For instance, the NMD 103 may download additional sounds from the computing devices 106c. Within examples, the NMD 103 might not practically be able to store all possible sounds in its library due to practical considerations such as cost and/or size of the NMD 103.

Alternatively, some or all of the library of sounds may be stored on another device. In some examples, another local device, such as one of the devices connected to the LAN 111 (FIG. 1B) may store the library of sounds. Such an implementation may be effective when certain devices have more computing resources (e.g., processing and/or data storage) than the NMD 103. Moreover, such an implementation may retain privacy as queries to the local library remain on the user's local network (e.g., the LAN 111). In further examples, some or all of the library may be stored in the cloud, such as on the computing devices 106c.

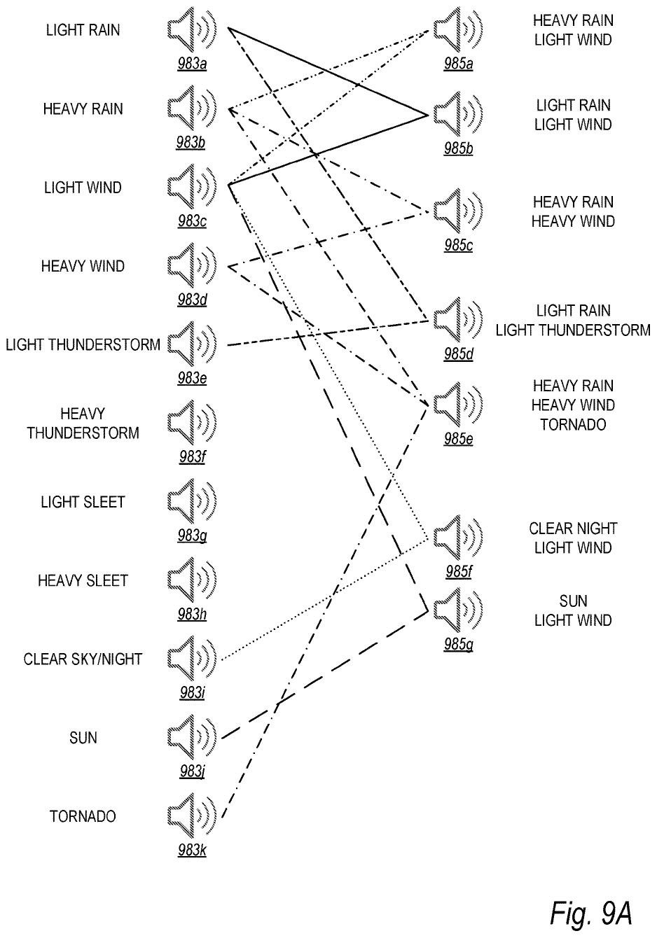

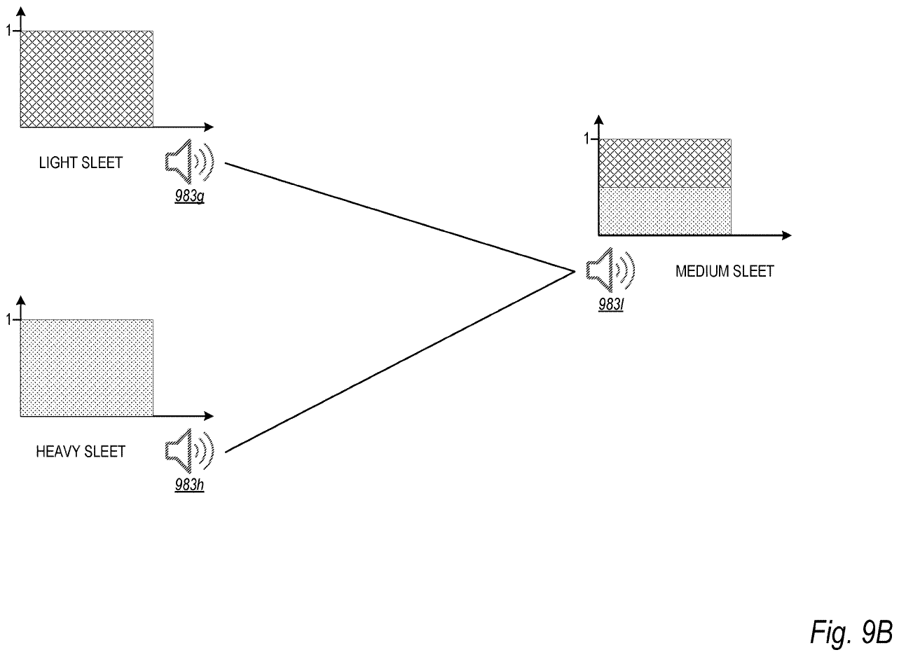

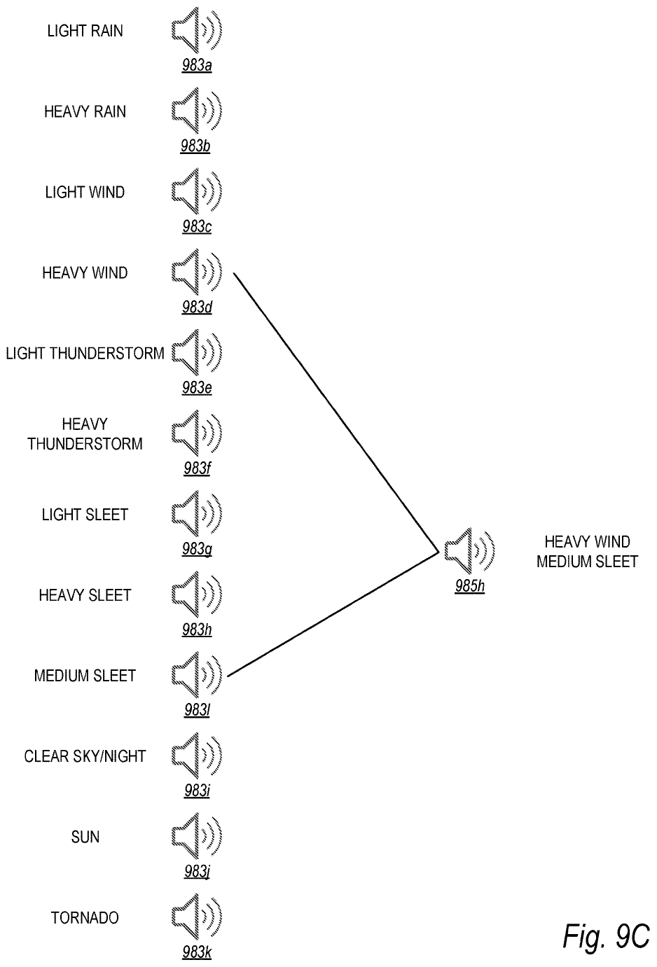

FIG. 9A illustrates example sound stacking of ambient, non-spoken sounds. The ambient, non-spoken sounds include an ambient sound 983a that represents light rain (e.g., via an ambient sound of mild rainfall on a roof, among other examples), an ambient sound 983b that represents heavy rain (e.g., via an ambient sound of intense rainfall on a roof), an ambient sound 983c that represents light wind (e.g., via a sound of a breeze rustling branches), and an ambient sound 983d that represents heavy wind (e.g., via a sound of a strong wind howling), an ambient sound 983e that represents a light thunderstorm (e.g., via a sound of thunder), an ambient sound 983f (e.g., via a sound of more intense, frequent thunder), an ambient sound 983g representing light sleet (e.g., via mild patter of sleet on a surface), an ambient sound 983h represent heavy sleet (e.g., via intense patter of sleet on a surface), an ambient sound 983i representing clear sky or a clear night (e.g., via a pleasant ambient sound, such as insect sounds like crickets chirping), an ambient sound 983j representing sun (e.g., via another pleasant ambient sound, such as birdsong), and an ambient sound 983k representing a tornado (e.g., via an intense wind sound). The ambient sounds 983a-983k, referred to collectively as ambient sounds 983, are representative of a library of ambient sounds that may be stacked. Other example sound libraries may include additional or fewer ambient sounds 983.

Each ambient sound 983 represents a respective weather condition (i.e., state) such that playback of an ambient sound conveys that state to a listener. Further, playback of two or more stacked ambient sounds 983 can concurrently convey multiple states to a listener when played back. While this example uses the ambient sound 983 to represent weather conditions, other examples may use different ambient sounds to represent states for other non-weather contexts, such as traffic (e.g., using different ambient sounds to represent levels of traffic intensity on a specific route, such as a commute), among other examples.

As shown in FIG. 9A, two or more of the ambient sounds 983 may be stacked to form a stacked sound representing two or more weather conditions. In particular, the ambient sound 983b and the ambient sound 983c are stacked to form a stacked sound 985a. Other combinations of the ambient sounds 983 are stacked to form a stack sound 985b, a stacked sound 985c, a stacked sound 985d, a stacked sound 985e, a stacked sound 985f, and a stacked sound 985g, which each represent different combinations of weather states. The stacked sounds 985a-985g, referred to collectively as the stacked sounds 985, may be played back by the NMD 103 to convey information about multiple states concurrently, perhaps at the same time as a spoken response is played back (e.g., as illustrated in FIG. 7B). One possible advantage of sound stacking is that many combinations of weather states can be represented using ambient sound without necessarily storing individual sounds for each combination.

In some examples, two or more ambient sounds 983 may be mixed prior to stacking to form a new ambient sound 983 that represents a state that is not represented specifically by an ambient sound 983 in the library. To illustrate, FIG. 9B show example sound mixing of the ambient sound 983g representing light sleet and the ambient sound 983h representing heavy sleet to form an ambient sound 983l that represents medium sleet. In this manner, the library of ambient sounds 983 can be expanded to represent additional states without necessarily storing additional ambient sounds 983. Such mixing may be triggered by receiving weather data representing a weather state that is not specifically represented in the sound library but can be considered a combination of two or more similar weather states that are represented using different intensities (e.g., heavy and light rain, heavy and light wind, or heavy and light thunderstorm, among other examples).

Within examples, rather than mixing the ambient sound 983g and the ambient sound 983h such that their individual sounds are added (which might result in a more intense sound than either ambient sound 983 alone), the sound are mixed proportionally to form the new ambient sound 983l. As a result, the ambient sound 983l that represents a condition in between heavy and light (i.e., medium). In this example, the ambient sound 983l may represent the weather condition of medium sleet via patter of sleet on a surface with the patter being somewhere between the mild and intense patter used as representation in the ambient sound 983g and the ambient sound 983h.

After two ambient sounds 983 are mixed to form a new ambient sound 983, the new ambient sound may be stacked with one or more additional ambient sounds to form a stacked sound 985. To illustrate, FIG. 9C shows the new ambient sound 9831 being stacked with the ambient sound 983d to form a stacked sound 985h. In this way, the scope of weather states and their combinations is further expanded (without necessarily storing individual ambient sounds representing each condition or combination).

### IV. Example Sound Stacking Techniques

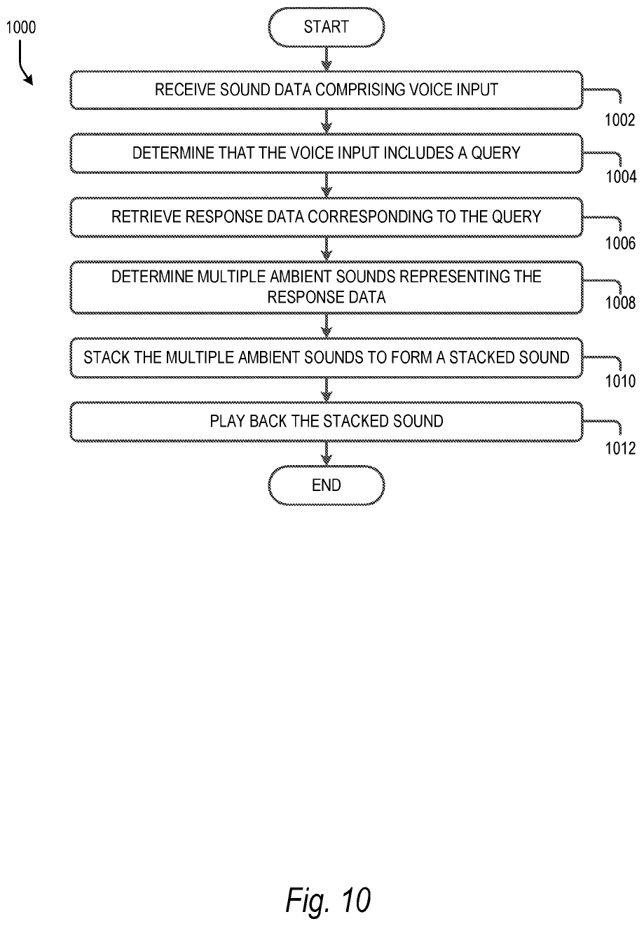

FIG. 10 is a flow diagram showing an example method 1000 to stack sounds for playback. The method 1000 may be performed by a NMD 103, such as the NMDs 103 (FIG. 1A), which may be stand-alone or integrated into a playback device 102, among other examples. Further, the method 1000 may be performed by two or more devices in cooperation, such as a bonded zone of playback devices 102 a group of playback devices 102 (FIGS. 3A-3E). Alternatively, the method 1000 may be performed by any suitable device or by a system of devices, such as any combination of the playback devices 102, the NMDs 103, control devices 104, computing devices 105, and/or computing devices 106, among other suitable devices. For the purposes of illustration, the method 1000 is described as being performed by the playback device 102d, which includes the integrated NMD 103c.

At block 1002, the method 1000 includes receiving sound data comprising a voice input. For instance, the playback device 102d may capture sound data representing the voice input 780b (FIG. 7A) using the microphones 222 (FIG. 2A) as described in connection with FIG. 2C, among other examples. As another example, the playback device 102d may receive sound data representing a voice input 780 captured by another NMD 103, such as the NMD 103f.

At block 1004, the method 1000 includes determining that the voice input includes a query. For instance, the playback device 102d may process the voice input 780b and determine that the voice input includes a query for specific information. The query may be a request for a weather forecast, among other types of information queries.

Within examples, determining that the voice input includes a query may include local voice input processing (e.g., as described in connection with FIGS. 2C-2D). Such local voice input processing may include automatic speech recognition to recognize keywords representing commands (such as “weather” to indicate a query for a weather forecast) or context (such as a location or date/time for a weather forecast). Further the local voice input processing may include intent determination (e.g., to determine that the recognized keywords represent a query for a weather forecast for a specific location at a particular day/time). Further details on local voice input processing are described in U.S. Pat. No. 11,556,307 filed Jan. 31, 2021, and titled “Local Voice Data Processing,” which is herein incorporated by reference in its entirety.

At block 1006, the method 1000 includes retrieving response data corresponding to the query. For instance, the playback device 102d may retrieve weather data representing a weather forecast from the weather data service 894 (FIG. 8). The playback device 102d may retrieve the response data from at least one server of a data service (e.g., the computing devices 806) via a network interface (e.g., the network interface 224 in FIG. 2A) and one or more networks (e.g., the networks 107 and/or the LAN 111). The retrieved data may include one or more values represented the queried information. For example, queried weather data may include a first weather characteristic representing a first aspect of a forecast (e.g., clear or rainy) and a second weather characteristic representing a second aspect of the forecast (e.g., wind), as well as possibly additional weather characteristic representing additional aspects of the forecast (e.g., weather events, such as thunderstorms, hurricanes, or tornados).

Retrieving response data may involve the playback device sending, via a network interface, to at least one remote service of a data service (e.g., the weather data service 894), a request for response data corresponding to the query (e.g., a request for a weather forecast for a particular time period at a particular location). As discussed in connection with FIG. 8, the data service may support an API, which expects queries according to a particular data structure that represents the query and values of an associated variables that modify the query. The playback device 102 may send a query according to this data structure (e.g., a structured query for weather data that includes values indicating a particular time period for the forecast (e.g., now, this evening, tomorrow, this week), a particular location (e.g., current location or another location, such as a city or postal code).

In some examples, processing the voice input may involve identifying keywords that represent the values that will be used in the query. For instance, the playback device 102d may determine that the voice input 780b includes a first keyword (or keywords) representing a particular location and a second keyword (or keywords) representing a particular time or date. The playback device 102d may then process these identified keywords into identifiers (e.g., strings or other data types) that can be used in the query.

In further examples, the voice input may exclude certain keywords that facilitate the query. For instance, the voice input may ask for a weather forecast without specifying the location and/or date/time of the desired forecast. In such instance, the playback device 102d may determine the current time and/or location and supply values corresponding these keywords in the query.

At block 1008, the method 1000 includes determining multiple ambient sounds representing the response data. For examples, the playback device 102d may determine, from a plurality of ambient sounds stored in data storage, multiple ambient sounds representing the weather data. Such ambient sounds may include a first ambient sound representing a first weather characteristic and a second ambient sound representing a second weather characteristic, as well as possibly additional ambient sounds representing additional weather characteristics.

Determining the ambient sounds may involve identifying a particular ambient sound that corresponds to a characteristic represented in the weather data. As noted above, the weather data service 894 may provide weather data according to a defined scheme. This scheme may include particular values representing various weather characteristics, which can be included in the weather data to indicate that the weather characteristics are part of the forecast. These values may be correlated to particular ambient sounds in a data structure, such as a table, which the playback device 102d may reference to determine the ambient sounds. Other examples are possible as well.

Yet further, determining the ambient sounds may involve determining that the response data includes a characteristic that does not have a particular corresponding ambient sound. For instance, the weather data may include a weather characteristic describing a weather intensity (e.g., medium sleet) that does not have a corresponding ambient sound. As another example, the weather data may include a weather characteristic describing a weather event (e.g., hurricane) that does not have a corresponding ambient sound.

In such instances, the method 1000 may involve combining two or more ambient sounds to form a new ambient sound representing the weather characteristics. For instance, the playback device 102d may combine the ambient sound 983g representing light sleet (e.g., a first intensity) and the ambient sound 983h representing heavy sleet (e.g., a second intensity) to form a new ambient sound 9831 representing medium sleet (e.g., a third intensity), as described in connection with FIG. 9B. As another example, the playback device 102d may combine the ambient sound 983b representing heavy rain, the ambient sound 983d representing heavy wind, and/or the ambient sound 983k representing a tornado to form a new ambient sound 983 representing a hurricane.

At block 1010, the method 1000 includes stacking the multiple ambient sounds to form a stacked sound. For instance, the playback device 102d may stack a first ambient sound (e.g., the ambient sound 983a) and a second ambient sound (e.g., the ambient sound 983c) to form a stacked sound (e.g., the stacked sound 985b), as described in connection with FIG. 9A. In some examples, stacking the sounds involves mixing the ambient sounds and modifying the sounds in one or more frequency bins to remove artifacts.

At block 1012, the method 1000 includes playing back the stacked sound. For example, the playback device 102d may play back the stacked sound via at least one audio transducer (e.g., the speakers 218). Within examples, the playback device 102d may play back the stacked sound concurrently with a spoken response to the voice input.

In some examples, the playback device 102d determines the spoken response. For instance, the playback device 102d may construct or otherwise generate the spoken response by performing text-to-speech processing on the retrieved weather data representing the weather forecast. Such processing may involve generating speech from weather characteristics represented in the weather data and combining such speech with pre-generated or generated on-the-fly spoken responses engineered for modification with different values based the weather characteristics representing a forecast.

Alternatively, the spoken response may come from a voice assistant service, such as the VAS 190 (FIG. 1B). For instance, the playback device 102d may send the voice input 780b to the computing devices 106b for processing by the VAS 190 (e.g., in addition to performing local processing to facilitate query of a data service). The computing devices 106b may then send back a spoken response for play back.

In some examples, the playback device 102d is configured in a bonded zone of play back devices 102 or a group of playback devices 102, as described in connection with FIGS. 3A-3E. In such cases, playback of the stacked sound may involve synchronous playback of the sound on the bonded and/or grouped playback devices 102. For instance, the playback device 102d in the living room 101f may play back the stacked sounds and the spoken response concurrently in synchrony of playback of the same audio by the playback device 102i in the kitchen 101h, among other examples.

In further examples, the method 1000 may also involve play back of audio content. For instance, the playback device 102d may receive, via a network interface (e.g., the network interface 224), instructions to play back particular audio content (e.g., from a control device 104 or from the computing device 106). Based on receiving such instructions, the playback device 102d may stream, via the network interface from at least one remote server of a streaming audio service (e.g., the computing devices 106b of the MCS 192), data representing the particular audio content. The playback device 102d may then play back, via at least one audio transducer (e.g., the speakers 224), the particular audio content.

Within examples, the playback device 102d may play back audio via a cloud queue that is stored in data storage of one or more remote computing devices. For instance, the particular audio content may include a playlist of audio tracks that is queued on a cloud queue that is maintained in data storage on the computing devices 106c, which may be configured to provide a platform service to enhance the media playback system 100 through various features, such as implementation of a cloud queue.

In such examples, playing back the particular audio content may include synchronization of a portion of cloud queue to a local queue. In particular, the playback device 102d may queue, in a local queue in the data storage, a first window of media items from the cloud queue. The first window includes at least a portion of the audio tracks in the playlist. Then playback device 102d may then play back the cloud queue via the first window and second windows of media items from the cloud queue that represent subsets of the cloud queue. Further details on cloud queue synchronization are described in U.S. Pat. No. 9,654,459 filed Feb. 6, 2015, and titled “Cloud Queue Synchronization Protocol,” which is herein incorporated by reference in its entirety.

### Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

Example 1: A method to be performed by a playback device comprising at least one audio transducer, at least one microphone, a network interface, at least one processor; and a housing carrying the at least one audio transducer, the at least one microphone, the network interface, and the at least one processor, and the method comprising receiving, via the at least one microphone, sound data comprising a voice input; determine that the voice input includes a request for a weather forecast; retrieving, via the network interface, weather data representing a weather forecast, the weather data comprising a first weather characteristic and a second weather characteristic; determining, from a plurality of ambient sounds stored in the data storage, multiple ambient sounds representing the weather data, the multiple ambient sounds comprising (i) a first ambient sound representing the first weather characteristic and (ii) a second ambient sound representing the second weather characteristic; and responsive to determining that the voice input includes the request for the weather forecast, playing back, via the at least one audio transducer, (i) a voice response representing the weather data in spoken words and (ii) concurrently with the voice response representing the weather data in the spoken words, the multiple ambient sounds such that playback of the first ambient sound and play back of the second ambient sound form a combined ambient sound representing the weather data.

Example 2: The method of Example 1, wherein playing back the first ambient sound and the second ambient sound comprise stacking the first ambient sound and the second ambient sound into the combined ambient sound; and playing back the combined ambient sound concurrently with the voice response representing the weather data in the spoken words.

Example 3: The method of Example 2, wherein the first ambient sound represents a particular type of weather to a first intensity, wherein the second ambient sound represents the particular type of weather to a second intensity, and wherein stacking the first ambient sound and the second ambient sound into the combined ambient sound comprises combining the first ambient sound and the second ambient sound into the combined ambient sound to represent the particular type of weather to a third intensity that is different from the first intensity and the second intensity.

Example 4: The method of Example 2, whether the plurality of ambient sounds stored in the data storage exclude an ambient sound representing the first weather characteristic, and wherein determining the multiple ambient sounds comprises combining two or more ambient sounds in the plurality of ambient sounds to form the first ambient sound representing the first weather characteristic.

Example 5: The method of any of Examples 1-4, wherein determining that the voice input includes the request for a weather forecast comprises determining, via a local voice assistant on the playback device, that the sound data comprising the voice input represents the request for the weather forecast, wherein the playback device foregoes sending the sound data to a cloud-based voice assistant.

Example 6: The method of any of Examples 1-5, further comprising: determining, via text-to-speech processing on the retrieved weather data representing the weather forecast, the voice response representing the weather data in spoken words.

Example 7: The method of any of Examples 1-6, wherein retrieving the weather data comprises: sending, via the network interface to at least one remote server of a weather data service, a request for a weather forecast for a particular time period at a particular location; and receiving, via the network interface, the weather data, the received weather data representing the weather forecast for the particular time period at the particular location.

Example 8: The method of Example 7, wherein determining that the voice input includes the request for a weather forecast comprises determining, via a local voice assistant, that the voice input includes speech representing the particular location.

Example 9: The method of Example 7, wherein determining that the voice input includes the request for a weather forecast comprises determining, via a local voice assistant, that the voice input excludes speech representing the particular time and the particular location, and wherein sending the request for a weather forecast for a particular time period at a particular location comprises send, via the network interface to the at least one remote server of the weather data service, a request for a weather forecast for a current time period at a current location.

Example 10: The method of any of Examples 1-9, further comprising: receiving, via the network interface, instructions to play back particular audio content; streaming, via the network interface from at least one remote server of a streaming audio service, data representing the particular audio content; and playing back, via the at least one audio transducer, the particular audio content

Example 11: The method of Example 10, wherein the particular audio content comprises a playlist of audio tracks, wherein the playlist of audio tracks is queued in a cloud queue that is maintained on at least one remote server of a platform service, and wherein receiving the instructions to play back particular audio content comprises queuing, in a local queue in the data storage, a first window of media items from the cloud queue, the first window including at least a portion of the audio tracks in the playlist; and playing back the cloud queue via the first window and second windows of media items from the cloud queue that represent subsets of the cloud queue.

Example 12: The method of Example 10, wherein the first weather characteristic represents a first type of weather, and the second weather characteristic represents a second type of weather.

Example 13: The method of Example 10, wherein the first type of weather corresponds to a type of precipitation, and the second type of weather corresponds to a weather event.

Example 14: A tangible, non-transitory, computer-readable medium having instructions stored thereon that are executable by one or more processors to cause a device to perform the method of any one of Examples 1-13.

Example 15: A media playback system comprising a playback device, the media playback system configured to perform the method of any one of Examples 1-13.

Example 16: A device comprising at least one speaker, a network interface, a microphone, one or more processors, and a data storage having instructions stored thereon that are executable by the one or more processors to cause the device to perform the method of any of Examples 1-13.

1-22. (canceled)

23. A playback device comprising:
at least one audio transducer;
at least one microphone;
a network interface;
at least one processor;
a housing carrying the at least one audio transducer, the at least one microphone, the network interface, and the at least one processor; and
data storage comprising instructions that are executable by the at least one processor such that the playback device is configured to:
receive, via the at least one microphone, sound data comprising a voice input;
determine that the voice input includes a request for a weather forecast;
retrieve, via the network interface, weather data representing a weather forecast, the weather data comprising a first weather characteristic and a second weather characteristic;
determine, from a plurality of ambient sounds stored in the data storage, multiple ambient sounds representing the weather data, the multiple ambient sounds comprising (i) a first ambient sound representing the first weather characteristic and (ii) a second ambient sound representing the second weather characteristic; and
responsive to the determination that the voice input includes the request for the weather forecast, play back, via the at least one audio transducer, (i) a voice response representing the weather data in spoken words and (ii) concurrently with the voice response representing the weather data in the spoken words, the multiple ambient sounds such that playback of the first ambient sound and playback of the second ambient sound form a combined ambient sound representing the weather data.

24. The playback device of claim 23, wherein the instructions that are executable by the at least one processor such that the playback device is configured to play back the first ambient sound and the second ambient sound comprise instructions that are executable by the at least one processor such that the playback device is configured to:
stack the first ambient sound and the second ambient sound into the combined ambient sound; and
play back the combined ambient sound concurrently with the voice response representing the weather data in the spoken words.

25. The playback device of claim 24, wherein the first ambient sound represents a particular type of weather to a first intensity, wherein the second ambient sound represents the particular type of weather to a second intensity, and wherein the instructions that are executable by the at least one processor such that the playback device is configured to stack the first ambient sound and the second ambient sound into the combined ambient sound comprise instructions that are executable by the at least one processor such that the playback device is configured to:
combine the first ambient sound and the second ambient sound into the combined ambient sound to represent the particular type of weather to a third intensity that is different from the first intensity and the second intensity.

26. The playback device of claim 24, whether the plurality of ambient sounds stored in the data storage exclude an ambient sound representing the first weather characteristic, and wherein the instructions that are executable by the at least one processor such that the playback device is configured to determine the multiple ambient sounds comprise instructions that are executable by the at least one processor such that the playback device is configured to:
combine two or more ambient sounds in the plurality of ambient sounds to form the first ambient sound representing the first weather characteristic.

27. The playback device of claim 23, wherein the instructions that are executable by the at least one processor such that the playback device is configured to determine that the voice input includes the request for a weather forecast comprise instructions that are executable by the at least one processor such that the playback device is configured to:
determine, via a local voice assistant on the playback device, that the sound data comprising the voice input represents the request for the weather forecast, wherein the playback device foregoes sending the sound data to a cloud-based voice assistant.

28. The playback device of claim 23, wherein the data storage further comprises instructions that are executable by the at least one processor such that the playback device is configured to:
determine, via text-to-speech processing on the retrieved weather data representing the weather forecast, the voice response representing the weather data in spoken words.

29. The playback device of claim 23, wherein the instructions that are executable by the at least one processor such that the playback device is configured to retrieve the weather data comprise instructions that are executable by the at least one processor such that the playback device is configured to:
send, via the network interface to at least one remote server of a weather data service, a request for a weather forecast for a particular time period at a particular location; and
receive, via the network interface, the weather data, the received weather data representing the weather forecast for the particular time period at the particular location.

30. The playback device of claim 29, wherein the instructions that are executable by the at least one processor such that the playback device is configured to determine that the voice input includes the request for a weather forecast comprise instructions that are executable by the at least one processor such that the playback device is configured to:
determine, via a local voice assistant, that the voice input includes speech representing the particular location.

31. The playback device of claim 29, wherein the instructions that are executable by the at least one processor such that the playback device is configured to determine that the voice input includes the request for a weather forecast comprise instructions that are executable by the at least one processor such that the playback device is configured to:
determine, via a local voice assistant, that the voice input excludes speech representing the particular time and the particular location, wherein the instructions that are executable by the at least one processor such that the playback device is configured to send the request for a weather forecast for a particular time period at a particular location comprise instructions that are executable by the at least one processor such that the playback device is configured to:
send, via the network interface to the at least one remote server of the weather data service, a request for a weather forecast for a current time period at a current location.

32. The playback device of claim 23, wherein the data storage further comprises instructions that are executable by the at least one processor such that the playback device is configured to:
receive, via the network interface, instructions to play back particular audio content;
stream, via the network interface from at least one remote server of a streaming audio service, data representing the particular audio content; and
play back, via the at least one audio transducer, the particular audio content.

33. The playback device of claim 32, wherein the particular audio content comprises a playlist of audio tracks, wherein the playlist of audio tracks is queued in a cloud queue that is maintained on at least one remote server of a platform service, and wherein the instructions that are executable by the at least one processor such that the playback device is configured to receive the instructions to play back particular audio content comprise instructions that are executable by the at least one processor such that the playback device is configured to:
queue, in a local queue in the data storage, a first window of media items from the cloud queue, the first window including at least a portion of the audio tracks in the playlist; and
play back the cloud queue via the first window and second windows of media items from the cloud queue that represent subsets of the cloud queue.

34. The playback device of claim 23, wherein the first weather characteristic represents a first type of weather, and the second weather characteristic represents a second type of weather.

35. The playback device of claim 34, wherein the first type of weather corresponds to a type of precipitation, and the second type of weather corresponds to a weather event.

36. A system comprising:
a playback device comprising at least one audio transducer, at least one microphone; and a housing carrying the at least one audio transducer and the at least one microphone;
a network interface;
at least one processor; and
data storage comprising instructions that are executable by the at least one processor such that the system is configured to:
receive, via the at least one microphone, sound data comprising a voice input;
determine that the voice input includes a request for a weather forecast;
retrieve, via the network interface, weather data representing a weather forecast, the weather data comprising a first weather characteristic and a second weather characteristic;
determine, from a plurality of ambient sounds stored in the data storage, multiple ambient sounds representing the weather data, the multiple ambient sounds comprising (i) a first ambient sound representing the first weather characteristic and (ii) a second ambient sound representing the second weather characteristic; and
responsive to the determination that the voice input includes the request for the weather forecast, play back, via the at least one audio transducer, (i) a voice response representing the weather data in spoken words and (ii) concurrently with the voice response representing the weather data in the spoken words, the multiple ambient sounds such that playback of the first ambient sound and playback of the second ambient sound form a combined ambient sound representing the weather data.

37. The system of claim 36, wherein the instructions that are executable by the at least one processor such that the system is configured to play back the first ambient sound and the second ambient sound comprise instructions that are executable by the at least one processor such that the system is configured to:
stack the first ambient sound and the second ambient sound into the combined ambient sound; and
play back the combined ambient sound concurrently with the voice response representing the weather data in the spoken words.

38. The system of claim 37, wherein the first ambient sound represents a particular type of weather to a first intensity, wherein the second ambient sound represents the particular type of weather to a second intensity, and wherein the instructions that are executable by the at least one processor such that the system is configured to stack the first ambient sound and the second ambient sound into the combined ambient sound comprise instructions that are executable by the at least one processor such that the system is configured to:
combine the first ambient sound and the second ambient sound into the combined ambient sound to represent the particular type of weather to a third intensity that is different from the first intensity and the second intensity.

39. The system of claim 37, whether the plurality of ambient sounds stored in the data storage exclude an ambient sound representing the first weather characteristic, and wherein the instructions that are executable by the at least one processor such that the system is configured to determine the multiple ambient sounds comprise instructions that are executable by the at least one processor such that the system is configured to:
combine two or more ambient sounds in the plurality of ambient sounds to form the first ambient sound representing the first weather characteristic.

40. The system of claim 36, wherein the instructions that are executable by the at least one processor such that the system is configured to determine that the voice input includes the request for a weather forecast comprise instructions that are executable by the at least one processor such that the system is configured to:
determine, via a local voice assistant on the playback device, that the sound data comprising the voice input represents the request for the weather forecast, wherein the playback device foregoes sending the sound data to a cloud-based voice assistant.

41. The system of claim 36, wherein the data storage further comprises instructions that are executable by the at least one processor such that the system is configured to:
determine, via text-to-speech processing on the retrieved weather data representing the weather forecast, the voice response representing the weather data in spoken words.

42. A tangible, non-transitory computer-readable medium comprising instructions that are executable by the at least one processor such that a playback device is configured to:
receive, via at least one microphone, sound data comprising a voice input;
determine that the voice input includes a request for a weather forecast;
retrieve, via a network interface, weather data representing a weather forecast, the weather data comprising a first weather characteristic and a second weather characteristic;
determine, from a plurality of ambient sounds stored in the data storage, multiple ambient sounds representing the weather data, the multiple ambient sounds comprising (i) a first ambient sound representing the first weather characteristic and (ii) a second ambient sound representing the second weather characteristic; and
responsive to the determination that the voice input includes the request for the weather forecast, play back, via at least one audio transducer, (i) a voice response representing the weather data in spoken words and (ii) concurrently with the voice response representing the weather data in the spoken words, the multiple ambient sounds such that playback of the first ambient sound and playback of the second ambient sound form a combined ambient sound representing the weather data.
